(19) United States
(12) Patent Application Publication
(10) Pub. No.: US 2005/0185787 A1
(43) Pub. Date: Aug. 25, 2005

(54) Method and apparatus for facilitating access to telephone communications

(75) Inventor: Cheong Heng Kow, Selangor (MY)

Correspondence Address: GIBBONS, DEL DEO, DOLAN, GRIFFINGER & VECCHIONE, 1 RIVERFRONT PLAZA, NEWARK, NJ, 07102-5497, US

(73) Assignee: KCH Hi-Tech Sdn Bhd (Malaysian corporation)

(21) Appl. No.: 11/025,584

(22) Filed: Dec. 29, 2004

(30) Foreign Application Priority Data
Jan. 31, 2004 (MY) PI 20040302

(51) Int. Cl. H04M 1/00; H04M 3/00; H04M 15/00

(52) U.S. Cl. 379/355.04; 379/114.15; 379/356.01

(57) ABSTRACT

A dialer and calling card with SIM memory device and method of facilitating access to a telephone network by verifying the identification data (ID) of a subscriber dialing out of an originating telephone; detecting a dual tone multiple frequency (DTMF) signal of the first push button of a destination telephone number being dialed by the subscriber to determine if the call is a trunk or international call; in which event, an automatic dialing sequence is activated; otherwise, the destination telephone number's DTMF signal bypasses said automatic dialing sequence to connect and transmit said destination telephone number's DTMF signal to a public service telephone network (PSTN) for making a local call. The automatic dialing sequence activated includes retrievably storing the destination telephone number dialed by the subscriber; accessing a telephone network provided by a predetermined telephone service provider, and upon successful connection to the telephony network; transmitting the subscriber ID to the telephony service provider to enable subscriber call transaction accounting by the telephony service provider; and retrieving and transmitting the destination telephone number to the telephony service provider to enable connection to the destination telephone.

### BACKGROUND OF THE INVENTION

1. Technical Field

This invention relates to a method and apparatus for facilitating access to a telephone communications network. Specifically, it relates to a method of minimizing caller dialing in making a calling card telephone call. A dialer apparatus for use with a calling card is also disclosed.

2. Discussion of Related Art

With equal access rights for long-distance carriers, a user may choose a chosen carrier (usually preference is based on lower call rates) by dialing a designated push button (e.g. “9”) to obtain access to a local exchange and dial another series of numbers to obtain access to an inter-exchange to connect to the preferred carrier. Additional numbers may be required when dialing out of a hotel, for example, before the destination number is dialed.

Calling cards enable a user to access such preferred carrier from third party or public phones by a similar lengthy dialing sequence to be entered manually in order to reach the preferred carrier in addition to dialing the card number (which identifies the account or credit balance purposes) and personal identification pin, or PIN, number (for security purposes) upon being prompted by the carrier's calls control centre before dialing the destination number.

The number sequence to be dialed may vary according to the particular calling card being used and the particular calls control centre which directs the transaction. For example, one may dial “1-800-123-456” to connect to a toll-free number of the chosen carrier, enter a 10-digit card identification number “2000987654” followed by a hash (“#”) key, and a 6-digit PIN “654321” followed by another “#” key before actually dialing the destination phone number in a manner one would dial in making a Subscriber Trunk Dialing or STD call which may comprise of a 2- or 3-digit country code, another 2- to 3-digit area code, followed by a 6- to 8-digit destination phone number. Thus, it is common that a mistaken number is pressed during this long sequence comprising 40 or more numbers whereupon the user has to abort dialing and start the sequence all over again.

Thus, devices are introduced to simplify the operations required of the caller to make a calling card telephone call. These devices are known as dialers which are boxes connected and placed adjacent to a telephone set to allow a user to simply enter the telephone number in the making of a calling card telephone call. Dialer functions are also known to be incorporated into calling cards which makes such cards bulkier as components such as microprocessor, logic circuit, keypad, memory storage, dual tone multiple frequency (DTMF) generator, speaker and display need to be provided on the card such as that disclosed in U.S. Pat. No. 5,455,857 (McGuire) wherein the user would still have to learn to program the dialing sequence into the card's memory. Another limitation of this dialer card is it cannot be used with other devices such as an Internet-ready computer to make a Voice-over-Internet Protocol (VoIP) connection.

With the possibility of transmitting audio signals in the form of voice over the Internet using User Datagram Protocol over Internet Protocol or UDP/IP which is an unguaranteed delivery over the public Internet, an entire Voice-over-IP or VoIP industry has emerged, particularly after the adoption of the H.323 Internet Telephony Standard in March 1996 by the International Telecommunications Union-Telecommunications sector (ITU-T) which specifies the minimum standards that equipment must meet in order to send voice over the IP and other packet-switched network protocols where sound quality cannot be guaranteed. Several commercial VoIP carriers have emerged, offering businesses and consumers, telephone service over the public Internet or private IP networks.

A number of patents may be found in respect of dialers but none of these are specifically used for accessing VoIP telephony, particularly with calling card for access control being used in conjunction with the dialer.

### DISCUSSION OF THE PRIOR ART

U.S. Pat. No. 5,818,930 (Mark) discussed the availability of portable electronic information cards that may function as miniature autodialers programmed to store different phone numbers, and/or calling card, credit card or personal identification numbers. The autodialer may be used as a smart card which is capable of being acoustically coupled to a phone and being reprogrammed in response to acoustic signals, e.g. a string of DTMF tones. Apart from smart cards, calling cards, credit cards, paging devices, debit cards and other information card-type devices apart from autodialer devices are discussed. The DTMF tones are transmitted acoustically as the dialer is not electrically connected to the phone and therefore acoustic coupling to the phone is required.

U.S. Pat. No. 5,991,384 (Wulkan) discloses an autodialer device that includes a memory storage device for containing databases which may be initiated to automatically transmit PIN, access phone number, transactional protocol, etc. so that no further data input is required from the user except for the destination phone number just as in our proposed SIM card. It further enables the deployment of the autodialer in a various telephone network environments including (i) directly to a PSTN network (fully passive) and (ii) in a PBX/PABX environment prior to connecting to a PSTN network.

U.S. Pat. No. 5,596,637 (Arzoumanian) discloses an autodialer which automatically dials a pre-programmed calling card number, then dials a pre-programmed access number and optionally a pre-programmed PIN. Also disclosed are electrical circuitries for generating DTMF tones, microprocessor for processing logic flow for dialing the above numbers, including a selectable switch closure for selecting one of two numbers. The autodialer's electronic components disclosed are compact and may therefore be housed in portable and convenient sizes such as a credit card, pager and, as the most preferred embodiment, a wrist watch. As such there is no electrical connection with the phone and acoustic coupling thereto to transmit DTMF signals is required.

U.S. Pat. No. 4,870,679 (Hanna) is an early version of autodialer where its dialer table in its integrated circuit has a memory circuit with limited storage. Apart from the 3 access numbers, M1, M2 and M3, that may be stored in the memory circuit, its memory chip, MK53762, which is non-removable, may store up to 9 repertory numbers, each up to 18 digits, which are inadequate for today's purposes.

PCT/US96/04269 (published WO 96/1971) (Howard) discloses an autodialer which components may be integrated in a compact manner so that its microprocessor, DTMF generator and transducer, microphone, etc. may be embodiment in a miniaturized autodialer housing such as a keychain and as such requires acoustic coupling to the phone to transmit the DTMF signals.

### SUMMARY OF THE INVENTION

One aspect of the invention resides in a dialer that is electrically connected to a phone to electrically transmit DTMF tones rather through acoustic coupling. The dialer may be a compact device for connection to a phone as an attractive attachment or desktop accessory to the phone.

Another aspect resides in a calling card as an access control to the actuation of the dialer to bypass the default PSTN connection to connect to the VoIP gateway. To this end, memory or storage means is provided on the calling card for storage of account and PIN data in addition to the autodialing numbers.

A further aspect resides in respect of the calling card with memory device is to provide for multiple levels of code and data encryption so that the VoIP telephony service provider may set its own ID and access security measures, independently from the card manufacturer, before the card is put to sale to the public.

Still another aspect resides in respect of the calling card is to enable multiple uses for the calling card with memory device apart from as access control to the dialer. This includes access control to doors, computers, time-recording and the like, remote monitoring of the dialer status.

To these ends, the invention therefore provides for a method of facilitating access to a telephone network comprising:
(a) verifying the identification data (ID) of a subscriber dialing out of an originating telephone as having authorized access to said network;
(b) detecting a dual tone multiple frequency (DTMF) signal of the first push button of a destination telephone number being dialed by said subscriber;
(c) determining if said first push button is a designated push button for accessing a trunk or international call; wherein a designated push button detected activates an automatic dialing sequence; otherwise, said destination telephone number's DTMF signal bypasses said automatic dialing sequence to connect and transmit said destination telephone number's DTMF signal to a public service telephone network (PSTN) for making a local call;
wherein said automatic dialing sequence activated includes—
(d) retrievably storing said destination telephone number dialed by said subscriber;
(e) accessing at least one telephone network provided by a predetermined telephone service provider, and upon successful connection to said telephony network;
(f) transmitting said subscriber ID to said telephony service provider to enable subscriber call transaction accounting by said telephony service provider; and
(g) retrieving and transmitting said destination telephone number to said telephony service provider to enable connection to said destination telephone.
Preferably, the steps (a)-(g) are in the order recited above.

In one embodiment, the subscriber ID is encoded on a calling card and is verifiable by a dialer which is in DTMF communication with the originating telephone.

In another embodiment, the automatic dialing sequence further includes predetermined pause timing and sequences to wait out machine answering voice sequences of a predetermined telephony service provider before transmitting the requisite DTMF signal to proceed with the access. Preferably, a plurality of predetermined telephone service provider access numbers is stored for accessing the telephone service provider's gateway in step (e), each access number is dialed in a closed-loop sequential order until a connection is made.

In yet another embodiment, the subscriber call transaction accounting by said telephony service provider includes recalling remaining credit balance, call timing, destination rate calculation and the like to maintain an account of said subscriber, including providing a new credit balance upon terminating access to the telephone network. The preferred telephone network for implementing the present invention is an Internet telephony network including a Voice-over Internet Protocol (VoIP) network.

Preferably, calling cards are manufactured according to a method of the invention for programming a calling card for facilitating access to a telephone network wherein said calling card comprises memory storage means for storing at least one of the following:
(a) memory field for holding telephone service provider identification;
(b) access code for writing to memory field for holding dialing and subscriber identification; and
(c) memory field for holding dialing information and subscriber identification;
wherein each of the above memory fields and access code are independently accessible and programmable with encryption capability.

Preferably, the calling card manufacturer programs and encrypts the memory field for holding telephone service provider identification. Preferably still, the calling card manufacturer further programs and encrypts the access code for writing to memory field for holding dialing information and subscriber identification.

The calling card manufacturer may deliver the calling card to the correctly identified telephone service provider and informs said telephone service provider the access code for writing to memory field for holding dialing information and subscriber identification. The telephone network service provider may, using the access code provided by the calling card manufacturer, access the memory field for holding dialing and subscriber card identification, and further programs and encrypts dialing information and subscriber identification onto the calling card.

In addition, a calling card is provided for accessing a telephone network with memory storage means which has been programmed and encrypted to store at least one of the following:
(a) memory field for holding telephone service provider identification;
(b) access code for writing to memory field for holding dialing information and subscriber identification; and
(c) memory field for holding dialing information and subscriber identification;
wherein each of the above memory fields and access code are independently accessible and programmable with encryption capability.

Preferably, the card's memory storage means includes a Subscriber Identification Module (SIM) memory.

Also, a dialer is provided for facilitating access to a telephone network comprising:
(a) means for verifying a subscriber dialing out of an originating telephone as having a valid ID, including a reader for reading a calling card of said subscriber;
(b) means for detecting a dual tone multiple frequency (DTMF) signal of the first push button of a destination telephone number being dialed by said subscriber;
(c) means for determining if said first push button is a designated push button for accessing a trunk or international call; wherein upon a designated push button being detected, activates an automatic dialing sequence; otherwise, said destination telephone number's DTMF signal bypasses said automatic dialing sequence to connect and transmit said destination telephone number's DTMF signal to a public service telephone network (PSTN) for making a local call;
wherein said automatic dialing sequence activated includes—
(d) means for retrievably storing said destination telephone number dialed by said subscriber;
(e) means for accessing at least one telephone network provided by a predetermined telephone service provider, and upon successful connection to said telephony network;
(f) means for transmitting said subscriber ID to said telephony service provider to enable subscriber call transaction accounting by said telephony service provider; and
(g) means for retrieving and transmitting said destination telephone number to said telephony service provider to enable connection to said destination telephone.
Preferably, the steps (a)-(g) are in the order recited.

In one embodiment of the dialer, the subscriber ID is encoded on a calling card and is verified by the dialer which is in DTMF communication with the originating telephone. Preferably, the automatic dialing sequence further includes predetermined pause timing and sequences to wait out machine answering voice sequences of a predetermined telephony service provider before transmitting the requisite DTMF signals to proceed with the access.

In another embodiment, a plurality of predetermined telephone service provider access numbers is stored for accessing in step (e), each access number is dialed in a closed-loop sequential order until a connection is made. Preferably, the telephone network is an Internet telephony network including a Voice-over Internet Protocol (VoIP) network.

Further, a telephone transaction system is provided comprising a dialer in DTMF communication with an originating telephone, said dialer predisposed to accept a calling card to verify subscriber ID contained therein, wherein said system implements the following:
(a) verifying the identification data (ID) of a subscriber dialing out of an originating telephone as having authorized access to said network;
(b) detecting a dual tone multiple frequency (DTMF) signal of the first push button of a destination telephone number being dialed by said subscriber;
(c) determining if said first push button is a designated push button for accessing a trunk or international call; wherein a designated push button detected activates an automatic dialing sequence; otherwise, said destination telephone number's DTMF signal bypasses said automatic dialing sequence to connect and transmit said destination telephone number's DTMF signal to a public service telephone network (PSTN) for making a local call;
wherein said automatic dialing sequence activated includes—
(d) retrievably storing said destination telephone number dialed by said subscriber;
(e) accessing at least one telephone network provided by a predetermined telephone service provider, and upon successful connection to said telephony network;
(f) transmitting said subscriber ID to said telephony service provider to enable subscriber call transaction accounting by said telephony service provider; and
(g) retrieving and transmitting said destination telephone number to said telephony service provider to enable connection to said destination telephone.
Preferably, the steps (a)-(g) are in the order recited.

In one embodiment of the telephone transaction system, the subscriber ID is encoded on a calling card and is verified by a dialer which is in DTMF communication with the originating telephone. Preferably, the automatic dialing sequence further includes predetermined pause timing and sequences to wait out machine answering voice sequences of a predetermined telephony service provider before transmitting the requisite DTMF signal to proceed with the access.

In another embodiment, a plurality of predetermined telephone service provider access numbers is stored for accessing in step (e), each access number is dialed in a closed-loop sequential order until a connection is made. The subscriber call transaction accounting by said telephony service provider may preferably include recalling remaining credit balance, call timing, destination rate calculation and the like to maintain an account of said subscriber, including providing a new credit balance upon terminating access to the telephone network. Preferably, the telephone network is an Internet telephony network including a Voice-over Internet Protocol (VoIP) network.

In a specific embodiment of the system, a dialer may be provided to accept a calling card according to the invention to verify subscriber ID contained therein, arranged to perform at least one step according to the method of the invention in the implementation of access control of doors, computers, time-recording machines and like appliances. The implementation may further comprise supervisory control and data acquisition (SCADA) capabilities. An example of such SCADA capability is a method of remotely monitoring the status of a dialer at predetermined intervals by programming said dialer to automatically dial-in to a VoIP network via a predetermined VoIP telephone number to report to a remote monitoring centre. Preferably, a plurality of dialers connectable to the VoIP network are pre-programmed to automatically dial-in to a VoIP network on periodical staggered basis, including daily at different times of the day according to the times encoded on said calling card and/or dialer.

### BRIEF DESCRIPTION OF THE DRAWINGS

The present invention will be better understood with the following detailed description with reference to the accompanying drawings (apart from FIGS. 1 to 3 (Prior Art) which have been discussed above) which describe specific embodiments as non-limiting examples or illustration, in which:

FIG. 1 shows a schematic block diagram of the telephone and dialer with SIM card control access according to the present invention;

FIG. 2 shows a logic flowchart of the automatic dialing sequence of the dialer as a continuation from the schematic diagram of FIG. 1;

FIG. 3 shows a schematic flow chart of the manufacture and encoding of the SIM card according to the invention; and

FIG. 4 shows a proposed circuit diagram of an embodiment of a dialer according to the present invention.

### DETAILED DESCRIPTION OF THE INVENTION

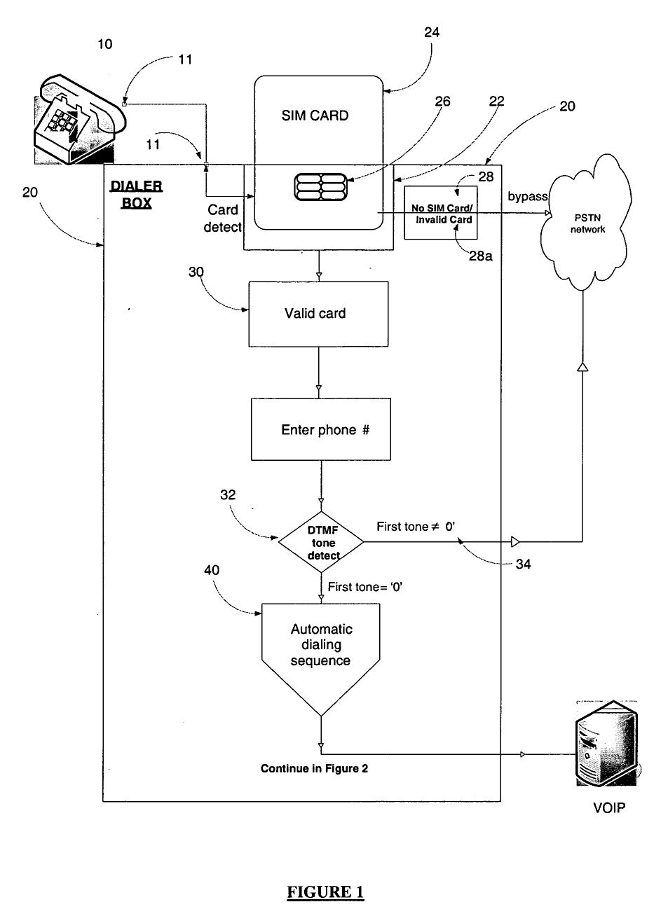

The method of the present invention in facilitating access to a telephone network, including a VoIP telephony service, may be better understood with reference to a telephone setup which is connected to a telecommunications network via a dialer according to the present invention as shown in FIG. 1. The telephone set 10 is electrically connected to the dialer 20 via standard telephone cables with RJ-11 jacks at both directions, i.e. to the telephone jack as well as to the wall outlet, to enable installation with ease.

The dialer 20 may be provided with a slot 22 for the calling card 24 to be inserted thereinto and automatically verified if it is a valid card. For this purpose, the calling card is preferably provided with a memory or data storage means 26 such as a Subscriber Identification Module, or SIM, memory device for containing data such as telephony service provider code, as the subscriber's account number and personal identification number (PIN) and remaining credit balance (for prepaid cards with or without automatic reload) or account code (e.g. for automatic reload or subscription based plans). Optionally, for security reasons, the card may only contain account code for identifying the account corresponding to the calling card wherein the details of the transactions and account balances are maintained at the telephony service provider's server.

The initial steps of the method generally comprise inserting a valid calling card 24 into the designated slot 22 provided in the dialer for verifying the calling card's data contained in the SIM 26. The slot 22 may contain retractable or biased contact pins for contacting the contact pads of the SIM memory device 26 to enable reading thereof whereby, in the absence of the card 24, the pins may extend to initiate or reroute to circuit 28 which bypasses the dialer and connects the phone directly to the PSTN line (or default line in a PBX or PABX environment).

The data contained in the SIM 26 is read and processed by the logic circuits of the dialer which may include microprocessors and other devices which will be described in detail later. To ensure that an invalid card remaining in the slot 22 does not incapacitates the dialer 20, a logic circuit bypass 28a to the PSTN line may be incorporated with the SIM card slot reader in addition to the physical (i.e. contact pins) circuit bypass.

As the validation of the calling card is a matter of coding the selected telephony service provider's code onto the calling card's SIM memory device 26, it is possible to configure the dialer 20 to accept more than one telephony service provider codes to make the dialer 20 a “multiple service provider” or “universal” dialer while maintaining separate dialing sequences to the gateways of each of the telephony service provider depending on the unique coding of the calling cards issued by the particular service provider.

Upon the detection of a valid calling card 30 in its card reader slot 22, the dialer is ready to read the destination phone number's DTMF signals generated by the telephone set 10 as it is dialed by the user. The destination phone number's DTMF signals are detected 32 in respect of its first digit to determine if it is a prescribed tone for accessing trunk or long-distance call. For example, where the PSTN employs “0” digit as the prescribed tone, if “0” is detected, the dialer's automatic dialing sequence circuitry 40 may be activated; otherwise the dialer would recognize that the dialed number is a local call and automatically re-routes 34 the DTMF signal string to the PSTN network.

The dialer may also be programmed to recognize a different prescribed tone, e.g. the hash (“#”) or asterisk (“*”), depending on the particular PSTN carrier in prescribing the specific DTMF tone to access trunk or long-distance call.

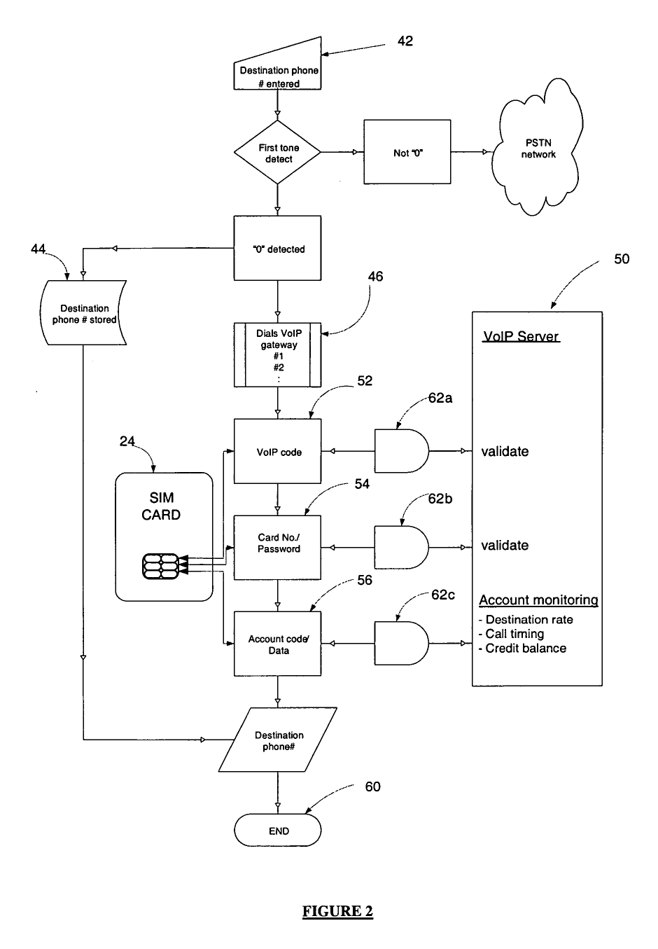

FIG. 2 shows in detail the automatic dialing sequence (40) of the dialer upon the detection of the prescribed DTMF tone for a trunk or long-distance call. In the shown example of “0” as the prescribed trunk call access tone, upon the detection of the DTMF tone for “0” for the first digit of the dialed destination phone number string 42, the entire phone number string is stored 44 in memory while the dialer initiates a gateway dialing sequences 46 based on a list of primary, secondary and other alternative VoIP gateway numbers. FIG. 2 shows a gateway dialing sequence having a list of 3 numbers to be dialed which are preferably arranged in a close loop so that the numbers are each dialed in turn until a successful connection to the VoIP server or gateway 50 is obtained.

Upon the successful connection to the VoIP server 50, an interrogation sequence may be initiated to determine any one or more of the codes or passwords stored in the calling card 24 now slotted into the dialer 20 to identify the card or subscriber. If the VoIP service provider's (IPS) code embedded in the SIM memory device 26 of the calling card 24 has not been verified at the beginning when the card is inserted into the dialer, the IPS code will be verified 52. In the same manner, the subscriber ID, card number or password embedded in the SIM memory device 26 will be read by the dialer and transmitted to the VoIP server 50 to be compared against a database in the server to be verified 54.

Finally, the account code is verified 56 before the VoIP server 50 accepts the user's attempt to connect whereupon the destination phone number 44 is retrieved and transmitted to the VoIP server 50 for completing the connection. The VoIP server 50 may then monitor the connection for timing and accounting purposes 58 so that the credit balance of the calling card may be deducted accordingly, or in the case of subscription-based calling card, the account be debited accordingly upon the termination of the connection 60. It would be obvious to a skill person that the above-mentioned order of verifying the IPS code, subscriber ID and account code need not be performed in the specific order as described. For instance, the verification of the IPS code may be performed automatically by the dialer upon the insertion of the calling card 24 into the card reader slot 22 of the dialer 20 as described earlier. The interrogation by the VoIP server may also be configured, for instance, to seek account code first followed by the subscriber ID.

To cater for automatic voice-assisted call systems employed by certain VoIP servers, timed delay or pause sequence 62a, 62b, 62c may be provided by appropriate programming of the automatic dialing sequence 40. Such delayed response or pauses is similar to certain phone systems which, by dialing the hash (“#”) button or generating its DTMF tone, inserts a 1.5 seconds delay in a speed dialing or in software-based, e.g. the Windows™ operating system, the comma “,” inserts a 2-second pause in the dialing sequence.

Where the voice-assisted call systems is provided with DTMF cut-through feature (i.e. capable of receiving DTMF tones while the voice synthesizer is playing back, e.g. a menu option, so the detection of a DTMF tone will cut short the voice playback and the system respond to the selection according to the DTMF tone) such pause sequences may not be necessary. If there is no display unit (such as an LCD display) at the telephone set which enables the VoIP server to transmit the credit balance in DTMF tones to be transcribed, processed and displayed, the voice response system may be programmed to read out the credit balance to the user.

It is preferred that the calling cards used in this invention are of the pre-paid types in small denominations such as in the range of RM20 to RM50 to make attempts to hack the security code contained therein not worthwhile for the intending perpetrator or without causing serious financial loss to the user if the card is lost or stolen.

With the SIM or similar memory device on the card, information such as memory field for holding internet phone service provider (IPS) identification, access code for enabling the writing to memory field for holding dialing information and subscriber identification, and (upon the write-enabled of the memory field, write the dialing information and subscriber identification onto the card. Subscriber identification may include the calling card's ID. In the case of subscription-based or post-paid calling cards, the Subscriber ID may contain a code identifying the card to a particular subscriber, including his subscription or reload plans. A pre-paid calling card may only contain ID which identifies the card and the account number or credit balance, and may be discarded upon the credit amount is used up.

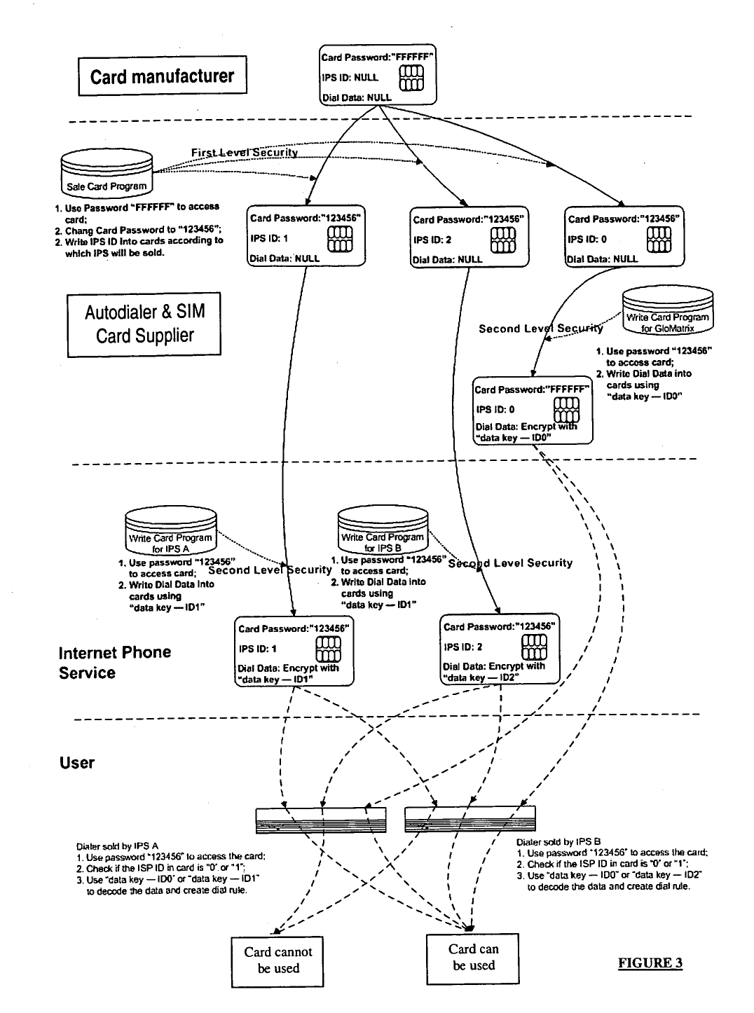

The process of manufacturing the calling cards, in particular the encoding of the above-mentioned information, may be described in detail with reference to FIG. 3 wherein is shown a calling card in the form of a SIM card being encoded at 3 levels of security protection. A generic blank SIM card is obtained from the SIM card manufacturer by the manufacturer 72 of the dialer system according to the present invention. The blank SIM card consigned to the dialer manufacturer 72 is provided with the initial password “FFFFF” to enable writing data onto the SIM card.

As the first level of security, the dialer manufacturer uses the password “FFFFF” to access the SIM card and changes the initial password “FFFFF” to “123456”. Assuming that the dialer manufacturer has calling card sales arrangement with 2 VoIP service providers (IPS), the manufacturer will write the ID of each of the 2 IPS onto the SIM cards, shown in FIG. 2 as “IPS ID: 1” (74) and “IPS ID: 2” (76) respectively. The SIM cards for IPS 1 (74) and IPS 2 (74) are delivered to the VoIP service providers (84) and (86) respectively.

For maintenance or troubleshooting purposes, the dialer manufacturer 72 may retain a SIM card which IPS ID is a universally-acceptable code for gaining access to any of its dialers irrespective of IPS. This is shown as SIM card 78 wherein the universal code is represented by “IPS ID: 0”.

As a second level of security, the IPS 84, 86 will use the password “123456” to write-enable the respective SIM cards 74a, 76a to be encoded with their respective automatic dialing sequence or Dial Data which are represented as “data key-ID 1” and “data key-ID 2” in FIG. 2. The Dial Data may comprise of card ID and/or subscriber ID, account number to enable the IPS server to identify it as a valid calling card to enable trunk or long-distance call connection as well as to record and maintain transaction accounting such as calculating destination rate and remaining credit balance. Although it is shown in the figure that both the IPS share the same write-enable password “123456”, it is possible to provide separate passwords to the IPS.

The IPS-encoded cards are now ready for distribution to the retailers and outlets of the respective marketing networks of the IPS 1 and IPS 2. As a third level of security, telephones installed or connected to a dialer according to the present invention wherein the dialers 94, 96 are sold by the respective IPS and are therefore programmed to validate only the calling cards issued by the same IPS. The dialer may be programmed to automatically use the password “123456” to access the card and check if the IPS ID is valid. In case of a positive validation, the dialer 94, 96 will use the Dial Data encoded in the SIM card to execute the automatic dialing sequence (as described above) to proceed with connecting to the VoIP server.

Depending on the requirements of the IPS, the dialer may be provided with means to translate DTMF signals from the VoIP server and write the translated signals onto the SIM card so that information such as account's credit balance may be written to the SIM memory device 26 of the card to update the credit balance.

The configuration of the dialer and SIM card according to the present invention may be modified or adapted to enable the system to be implemented in controlling the access to doors, computers and machines, attendance recording machines including time-based recording of attendance and other machines or appliances requiring such multiple level validation and control as above described. The implementation may also be controlled and accessed remotely via the telephone network, including Internet telephony, thus making the system having supervisory control and data acquisition (SCADA) capabilities.

The dialer and/or SIM card may be programmed with instructions to automatically dial-in to a VoIP network via a predetermined phone number to report to a remote monitoring centre of the working status of the dialer and telephone. To avoid congestion, a plurality of dialers may be so pre-programmed to automatically dial-in to the remote monitoring centre, which may be the VoIP server itself, on a periodical staggered basis, including daily at different times of the day. With this embodiment, the VoIP service provider is able to monitor the working status of its telephones and dialers at the cost of a local call (Internet access charge) for each dialer irrespective of the location and which small cost is borne by the owner of the telephone and dialer. This is in contrast with conventional dialer monitoring by a remote monitoring centre which dials out to each of the dialers using the PSTN lines.

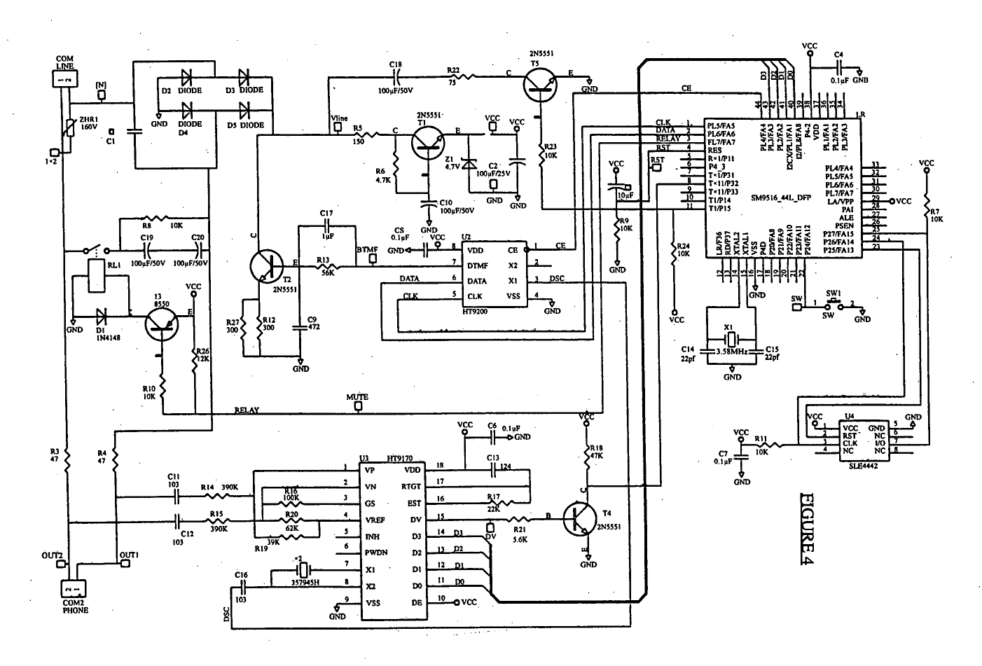

FIG. 4 shows a circuit diagram of the proposed dialer which a person skilled in the arts will be able to understand its conventional symbols and representations, and proceed to construct a prototype dialer and program it accordingly to achieve the present invention.

The dialer of the present invention may also be incorporated into a “call home” telephone such as those found in airports or hang-outs of foreign workers or pilgrimage centers whereby an immigrant may call home by dialing the telephone connected to a dialer according to the present invention which has been pre-programmed to dial the necessary prefix numbers so that the immigrant may dial the destination telephone number as if he is in his home country.

From the above description on the general concept, features and working principles of the invention and its specific embodiments, it would be obvious to a person skilled in the art that there are many variations and alternative embodiments that may be used in substitution of the aforesaid parts, materials, steps or processes. Many of the various parts, components, materials and alternative configurations or embodiments that are not specifically described herein may be used to effectively work the concept and working principles of this invention. They are not to be considered as departures from the present invention but shall be considered as falling within the letter and scope of the following claims.

1. A method of facilitating access to a telephone network comprising:
(a) verifying the identification data (ID) of a subscriber dialing out of an originating telephone as having authorized access to said network;
(b) detecting a dual tone multiple frequency (DTMF) signal of the first push button of a destination telephone number being dialed by said subscriber;
(c) determining if said first push button is a designated push button for accessing a trunk or international call; wherein a designated push button detected activates an automatic dialing sequence; otherwise, said destination telephone number's DTMF signal bypasses said automatic dialing sequence to connect and transmit said destination telephone number's DTMF signal to a public service telephone network (PSTN) for making a local call;
wherein said automatic dialing sequence activated includes—
(d) retrievably storing said destination telephone number dialed by said subscriber;
(e) accessing at least one telephone network provided by a predetermined telephone service provider, and upon successful connection to said telephony network;
(f) transmitting said subscriber ID to said telephony service provider to enable subscriber call transaction accounting by said telephony service provider; and
(g) retrieving and transmitting said destination telephone number to said telephony service provider to enable connection to said destination telephone.

2. A method according to claim 1, wherein the steps (a)-(g) are in the order recited.

3. A method according to claim 1, wherein the subscriber ID is encoded on a calling card and is verifiable by a dialer which is in DTMF communication with the originating telephone.

4. A method according to claim 1, wherein the automatic dialing sequence further includes predetermined pause timing and sequences to wait out machine answering voice sequences of a predetermined telephony service provider before transmitting the requisite DTMF signal to proceed with the access.

5. A method according to claim 1, wherein a plurality of predetermined telephone service provider access numbers is stored for accessing said service provider's gateway in step (e), each access number is dialed in a closed-loop sequential order until a connection is made.

6. A method according to claim 1, wherein the subscriber call transaction accounting by said telephony service provider includes recalling remaining credit balance, call timing, destination rate calculation and the like to maintain an account of said subscriber, including providing a new credit balance upon terminating access to the telephone network.

7. A method according to claim 1, wherein the telephone network is an Internet telephony network including a Voice-over Internet Protocol (VoIP) network.

8. A calling card for accessing a telephone network with memory storage means which has been programmed and encrypted to store at least one of the following:
(a) memory field for holding telephone service provider identification;
(b) access code for writing to memory field for holding dialing information and subscriber identification; and
(c) memory field for holding dialing information and subscriber identification;
wherein each of the above memory fields and access code are independently accessible and programmable with encryption capability.

9. A calling card according to claim 8, which memory storage means includes a Subscriber Identification Module (SIM) memory.

10. A method for programming a calling card according to claim 8, for facilitating access to a telephone network wherein said calling card comprises memory storage means for storing at least one of the following:
(a) memory field for holding telephone service provider identification;
(b) access code for writing to memory field for holding dialing and subscriber identification; and
(c) memory field for holding dialing information and subscriber identification;
wherein each of the above memory fields and access code are independently accessible and programmable with encryption capability.

11. A method according to claim 10, wherein the calling card manufacturer programs and encrypts the memory field for holding telephone service provider identification.

12. A method according to claim 11, wherein the calling card manufacturer further programs and encrypts the access code for writing to memory field for holding dialing information and subscriber identification.

13. A method according to claim 11, wherein the calling card manufacturer delivers the calling card to the correctly identified telephone service provider and informs said telephone service provider the access code for writing to memory field for holding dialing information and subscriber identification.

14. A method according to claim 12, wherein telephone network service provider, using the access code provided by the calling card manufacturer, accesses the memory field for holding dialing and subscriber card identification, and further programs and encrypts dialing information and subscriber identification onto the calling card.

15. A dialer for facilitating access to a telephone network comprising:
(a) means for verifying a subscriber dialing out of an originating telephone as having a valid ID, including a reader for reading a calling card of said subscriber;
(b) means for detecting a dual tone multiple frequency (DTMF) signal of the first push button of a destination telephone number being dialed by said subscriber;
(c) means for determining if said first push button is a designated push button for accessing a trunk or international call; wherein upon a designated push button being detected, activates an automatic dialing sequence; otherwise, said destination telephone number's DTMF signal bypasses said automatic dialing sequence to connect and transmit said destination telephone number's DTMF signal to a public service telephone network (PSTN) for making a local call;
wherein said automatic dialing sequence activated includes—
(d) means for retrievably storing said destination telephone number dialed by said subscriber;
(e) means for accessing at least one telephone network provided by a predetermined telephone service provider, and upon successful connection to said telephony network;
(f) means for transmitting said subscriber ID to said telephony service provider to enable subscriber call transaction accounting by said telephony service provider; and
(g) means for retrieving and transmitting said destination telephone number to said telephony service provider to enable connection to said destination telephone.

16. A dialer according to claim 15, wherein the steps (a)-(g) are in the order recited.

17. A dialer according to claim 15, wherein the subscriber ID is encoded on a calling card and is verified by said dialer which is in DTMF communication with the originating telephone.

18. A dialer according to claim 15, wherein the automatic dialing sequence further includes predetermined pause timing and sequences to wait out machine answering voice sequences of a predetermined telephony service provider before transmitting the requisite DTMF signals to proceed with the access.

19. A dialer according to claim 15, wherein a plurality of predetermined telephone service provider access numbers is stored for accessing in step (e), each access number is dialed in a closed-loop sequential order until a connection is made.

20. A dialer according to claim 15, wherein the telephone network is an Internet telephony network including a Voice-over Internet Protocol (VoIP) network.

21. A telephone transaction system comprising a dialer according to claim 15, in DTMF communication with an originating telephone, said dialer predisposed to accept a calling card to verify subscriber ID contained therein, wherein said system implements the following:
(a) verifying the identification data (ID) of a subscriber dialing out of an originating telephone as having authorized access to said network;
(b) detecting a dual tone multiple frequency (DTMF) signal of the first push button of a destination telephone number being dialed by said subscriber;
(c) determining if said first push button is a designated push button for accessing a trunk or international call; wherein a designated push button detected activates an automatic dialing sequence; otherwise, said destination telephone number's DTMF signal bypasses said automatic dialing sequence to connect and transmit said destination telephone number's DTMF signal to a public service telephone network (PSTN) for making a local call;
wherein said automatic dialing sequence activated includes—
(d) retrievably storing said destination telephone number dialed by said subscriber;
(e) accessing at least one telephone network provided by a predetermined telephone service provider, and upon successful connection to said telephony network;
(f) transmitting said subscriber ID to said telephony service provider to enable subscriber call transaction accounting by said telephony service provider; and
(g) retrieving and transmitting said destination telephone number to said telephony service provider to enable connection to said destination telephone.

22. A telephone transaction system according to claim 21, wherein the steps (a)-(g) are in the order recited.

23. A telephone transaction system according to claim 21, wherein the subscriber ID is encoded on a calling card and is verified by a dialer which is in DTMF communication with the originating telephone.

24. A telephone transaction system according to claim 21, wherein the automatic dialing sequence further includes predetermined pause timing and sequences to wait out machine answering voice sequences of a predetermined telephony service provider before transmitting the requisite DTMF signal to proceed with the access.

25. A telephone transaction system according to claim 21, wherein a plurality of predetermined telephone service provider access numbers is stored for accessing in step (e), each access number is dialed in a closed-loop sequential order until a connection is made.

26. A telephone transaction system according to claim 21, wherein the subscriber call transaction accounting by said telephony service provider includes recalling remaining credit balance, call timing, destination rate calculation and the like to maintain an account of said subscriber, including providing a new credit balance upon terminating access to the telephone network.

27. A telephone transaction system according to claim 21, wherein the telephone network is an Internet telephony network including a Voice-over Internet Protocol (VoIP) network.

28. A dialer according to claim 15, predisposed to accept a calling card to verify subscriber ID contained therein, arranged to access control of doors, computers, time-recording machines and appliances.

29. A dialer according to claim 28, further comprising supervisory control and data acquisition (SCADA) capabilities.

30. A method of remotely monitoring the status of a dialer according to claim 15, at predetermined intervals by programming said dialer to automatically dial-in to a VoIP network via a predetermined VoIP telephone number to report to a remote monitoring centre.

31. A method according to claim 30, wherein a plurality of dialers connectable to the VoIP network are pre-programmed to automatically dial-in to a VoIP network on periodical staggered basis, including daily at different times of the day according to the times encoded on said calling card and/or dialer.
